(19) United States
(12) Patent Application Publication
(10) Pub. No.: US 2025/0092893 A1
(43) Pub. Date: Mar. 20, 2025

(54) Magnetic mechanism of holding and moving a Hollow sphere / ball to a surface.

(71) Applicants: Austin Anthony Kelly, Dublin (IE); Connor Adam Kelly, Dublin (IE); Josh Austin Kelly, Dublin (IE); Pearse Michael Neeson, Ballymena (GB); Ronan Patrick Neeson, Ballymena (GB); Sean Gabriel Neeson, Ballymena (GB)

(72) Inventors: Austin Anthony Kelly, Dublin (IE); Connor Adam Kelly, Dublin (IE); Josh Austin Kelly, Dublin (IE); Pearse Michael Neeson, Ballymena (GB); Ronan Patrick Neeson, Ballymena (GB); Sean Gabriel Neeson, Ballymena (GB)

(21) Appl. No.: 18/470,673

(22) Filed: Sep. 20, 2023

(51) Int. Cl. F16B 1/00; A47G 29/08; F16M 13/02

(52) U.S. Cl. CPC F16B 1/00; A47G 29/08; F16M 13/022; F16B 2200/83

(57) ABSTRACT

A magnetic attachment system that secures a modified hollow ball shaped object to a surface where the balls total weight can be held in position without any mechanical form of fixing and provides methods of allowing it to move along the surface while secured to the surface. Having a metal contained inside or part of the ball and by using a surface as a in between object to the metal and a magnetic field such as a magnet, it would result in the ball being pulled towards and held the surface of the in-between object by their magnet attraction of the metal to the magnetic field Moving the magnetic field would make the ball move in the same direction as long as the magnetic attraction is strong enough. Now Vertical or greater angled surfaces can be used to hold and move a hollow ball on.

### BACKGROUND OF THE INVENTION

The typical movement of common hollow spherical objects, such as, footballs, tennis balls, pinballs, and more specifically, light weight plastic balls or ping pong balls to name only a few are mostly observed with the majority of their movements along a horizontal plane such as the ground. Balls have a hard time staying up due to Gravity wanting to push it back down.

So a ball does not naturally tend to keep it position or be suspended on any inclined, near vertical, vertical, greater than vertical surface (Like a wall or board for instance) without some form of mechanical fixing or aid or method to prevent it from falling or rolling off.

Generally to hold and/or move a hollow spherical object on the example surfaces mentioned, a mechanism would normally be used to physically be in contact with the surface of the sphere in order to hold it so it makes contact to the surface, and due to its shape, applying a movement force on the outside surface of the sphere to move it in any direction on example surfaces mentioned, and being able to maintain its position with a good degree of precision could prove to be expensive, complex and problematic, especially if different directions of movement are required.

The contact surfaces of a ball to a surface is very small and this makes any fixings even more difficult to design, especially if you want to keep the ball shape and minimise any visible fixing

Normally in order to hold a ball to a wall and move it, a fixing would leave a visible mechanism which would be coupled to some form of actuator to do this, and may not be suitable for every particular application.

Accordingly, there exists a need for a easier way to accomplish the issues mentioned that could open new possibilities in the entertainment/tourism industry in particular

### SUMMARY OF THE INVENTION

Accordingly, there is provided a magnetic mechanism of holding and moving a Hollow sphere/ball to a surface comprising of: at least one device/s that has or is capable of generating a magnetic field, a hollow plastic ball that has a ferromagnetic metal/s as part of it and/or inside of it; a board shaped object placed in-between the above two elements.

If you place the Ball next to the surface of the in-between board, and a magnetic field in close proximity on the other side of the board, the magnetic fields will attract the balls ferromagnetic metal/s to itself, and if strong enough will hold the ball to the surface of the in-between board, and even suspend it in mid air. If you moved the magnetic field, this in turn would drag the ball with it across the surface the ball is touching. By using directed movement methods in moving the magnetic field, you could have the ball follow a path, useful for many different application's. You could also control if it stays attached to the board by methods of weaking the magnetic field so it cannot hold the ball to the board surface.

By using magnetic forces, this device overcomes the need to have a visible fixing mechanism for attaching the ball to a surface where that ball is in contact with, nor does it have any physical contact to a hollow ball, but still holds the ball and in combination with directed movement techniques of the magnetic fields holding the ball, allows for its movement on the surface it is on, even on a vertical or greater surface.

The use of this mechanism could be adapted but not limited to, new ways to design board game, new forms of animated arcade or amusement attractions, new forms of animated advertising boards, animated scientific installations demonstrating things like the movement of cells in veins or bubbles raising, animated moving targets, animated planet orbits, animated art exhibitions, a way of transporting hollow balls from one location to another to name just a few.

No prior art to my knowledge uses a modified ball that identifies a means of suspending and moving a ball on a substantially inclined surface, and therefore, the inventor believes, makes it novel and a non-obvious invention.

### BRIEF DESCRIPTION OF DRAWINGS

FIG. 1 is an illustrative representation of the basic side view of the main parts and their normal arrangement, in accordance with embodiments of the present invention; and

FIG. 2 is an illustrative representation of two methods of moving the ball, depicted in an angled view that is showing the magnet side of the arrangement, where it shows two forms of channels that can be used to contain and guide a magnet, in accordance with embodiments of the present invention; and

FIG. 3 is an illustrative representation of a method of moving the ball, depicted in an angled view that is showing the magnet side of the arrangement, where it shows a directional support guiding a magnet along a path, in accordance with embodiments of the present invention; and

FIG. 4 is an illustrative representation of a method of moving the ball, depicted in an angled view that is showing the magnet side of the arrangement, where it shows the use of a actuator to move and guide a magnet along a path, in accordance with embodiments of the present invention

### DETAILED DESCRIPTION OF THE INVENTION

The modified hollow spherical object referenced here as “ball” and made form a lightweight material (for example plastic), whereby a Ferromagnetic metal (FM) would form part of the balls shell or make part of, or the whole of, the material used in a separate object contained inside of the ball cavity (for example a magnet), allowing the (FM) to be capable of being attracted to a magnetic field.

The FM could be in the form of a magnet/s, ball magnet, magnetic fluid, iron particles, curved metal plate, metal pin, magnetic fluid, steel ball)

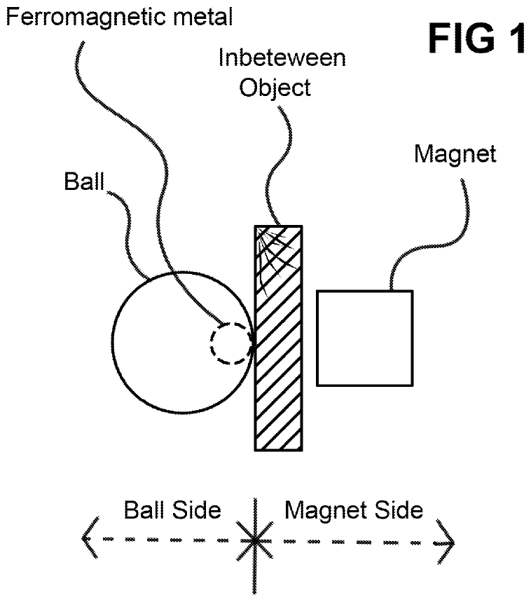

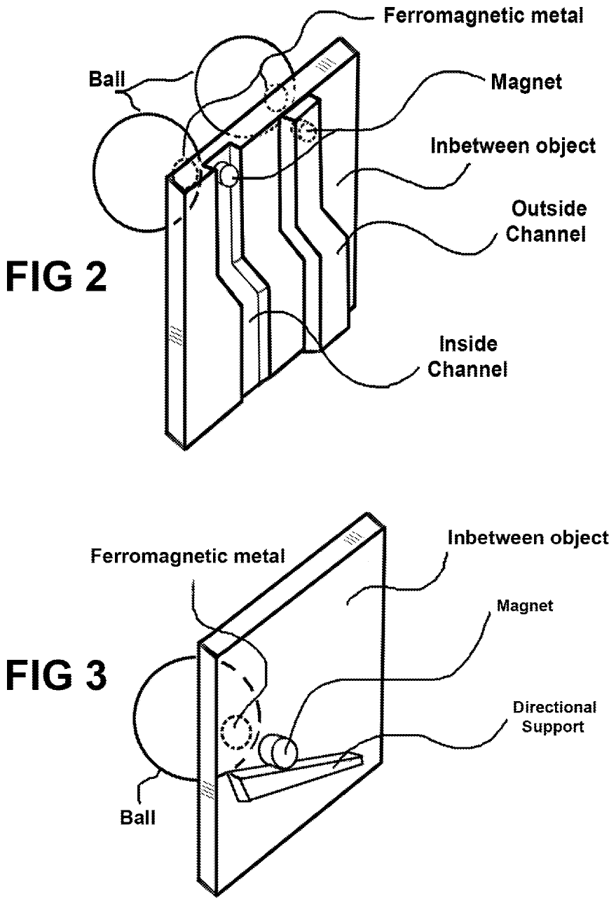

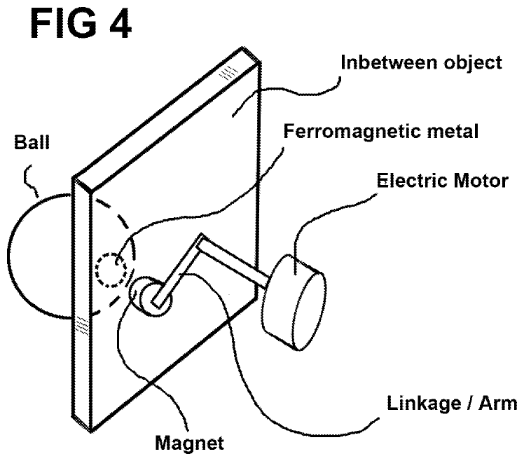

Generally the Ferromagnetic metal (FM) would be in the form of a Ball magnet contained inside of the BALL as its shape helps to assist with its smooth rolling across the inner surface of the balls surface aswell as magnifying the force it would exert on the balls surface, if it moved, due to its shape decreasing the friction between it and the curved inner wall of the ball, and by having a magnetic field of its own, only increases the likelihood of itself & ultimately the ball being attracted to any magnetic field nearby. The position of which, when locked on to the magnetic field, would draw the ball magnet to the closest point it could go to the magnetic fields, as is displayed in drawing (Reference FIG. 1)

The ball would make contact with a objects surface known as the “inbetween object” or “in-between object” (generally a flat board made of wood) but could consist of any material, more often a non magnetic material, especially where the ball touches the surface of the object (Ball Side). This “inbetween object”derives it name from always being located between the ball and one or more device/s or object/s that has, or is capable of, generating a magnetic field. This said “device or object” will be known/referenced here as the “Component”

The component's location would generally be very close to or even touch the closest surface of the inbetween object (Magnet side) where the attraction force would be strongest.

So the “inbetween object” generally takes to form of, of similar to that of a board, where that the majority of it consists of, a non-magnetic material, whereby the majority of its surface area is made up from two of its sides running in parallel or close to parallel with each other giving it two main side surfaces, with one of these side surfaces facing the said ball, will be known/referenced here as the (Ball Side), while its other side would be facing the Component and will be known/referenced here as the (Magnet Side), so that its position is between the (Ball Side) & (Magnet Side) as displayed in drawing (Reference FIG. 1)

Generally the Inbetween object would be secured to another support structure in order to keep it in position.

The Component always being located on the (Magnet Side) of the inbetween object, could take the form of any number of magnets or electric devices (ie an electromagnet), or a metal coil in an arrangement that it could have or create a magnetic field, however, If a electromagnetic device was used in the component part, due to its limited usage in becoming overheated over time, it would only be on for a limited period of time, therefore, for longer periods and for practically, generally it would be a Magnet as demonstrated in drawing (Reference FIG. 1)

The attracting force of the Components magnetic field/s to the FM allows for the ball to be pulled onto the ball side surface of the inbetween object, by the lockon of the FM to the Components magnetic field, and provides a form of invisible fixing/securing of the ball to the surface it is on.

If the FM has a magnetic field of its own . . . which it would generally have, this helps in this process of lock-on and holding.

At least one, or a combination of, the magnetic field/s that the component or number of components used to attract the FM towards it/them will be known/referenced here as the “Attraction force” and would provide enough attraction force or strength to hold the BALL to the ball side surface of the inbetween object so that its tendency to stay in a locked position is more than that of it naturally rolling away or falling away from the surface and/or it would be capable of supporting the weight of ball and any of its associated FM objects that may be inside it or form part of it.

This support would result in the ball looking like it is stuck to the surface without any other visible sign of support and be able to move along it, if the component was moved, like it was moving along the ground but the surface would be possibly in a vertical position or greater, giving the illusion that gravity does not effect it and as it seems to move by itself, giving it the illusion its got a mind of its own. At least it would be very novel and interesting to look at.

Where the surface is on an incline or slope, More often this attraction force would be enough to suspend the ball and prevent it from rolling or falling off the surface

The strength of the hold of the ball to the surface it has contact with could be influenced in any embodiment by any of the following:
the number of FM's used,
the strength of the magnetic field of any FM's used (if it exists)
the weight of the Ball and the FM's are used,
the strength of the FM's or component/s magnetic field,
a change in the distance or gap between the location of the FM's on the ball and the location of the component/s resulting in the attraction force increasing or decreasing. which inturn can effect the balls movement behaviour when moving aswell as its behaviour when exposed to other outside forces (if the ball is moving or not).
The extent of the force of gravity on the hollow ball due to position of it on the surface it is on
The environment that the hollow ball is in.
Any outside forces that might be applied to the hollow ball itself. Ie (air flow, another object pushing, sucking or colliding with it, water colliding with it, another magnetic force interacting with the said objects on or inside of it)
The surface it is on or moving onto or changing in terms of its material makeup, thickness, consistency, or surface makeup.

A more detailed manipulation the above elements that embodiment's of the device use could take the form of

The manipulation of the “Attraction force” whereby it can be “if possible” turned on, increased or decreased in strength, turned off.

One form of this said distance/gap manipulation could be in the form of changing the thickness of the surface that the hollow ball is on; either by the inbetween surfaces own thickness or by securing to any other surface between the FM and the component, anything or material component that would cause the thickness to increases that would result in the increase of the distance/gap.

another form of this manipulation that could exist is the thickness is gradually increased with the introduction of an incline or other shaped material component either by its own thickness or the attachment to the surface of a shaped component that would introduce this incline.

another form of this manipulation that could exist could by using different thickness of the wall of the ball is made from.

One form of this said distance manipulation could be in the form of the result of a mechanical movement of any part linked to the ball or the component

Another form of this manipulation that could exist could be where a space/air gap exists, or is introduced, between the FM and the component and any one or combination of forms of manipulation but not limited to the ones described here could be used to alter be hold strength of the Hollow ball to the surface that it is on. t

Another form of this manipulation that could exist could be where a space/air gap exists, or is introduced, between the FM and the component and any one or combination of these forms of manipulation but not limited to the ones described here could be used to alter be hold strength of the Hollow ball to the surface that it is on

An Embodiment of the device where this could be used very effectively is in a target game design, using the balls as targets, and if an object being aimed at the ball, hits the ball, it could cause the ball to become detached.

In another use, transporting the balls on the surface and making them detach if necessary.

These forms of manipulation are useful in making the ball more susceptible to detaching from the surface and can be used to break its magnetic bond of the Attraction force holding it to the surface causing it to detach (roll off or fall away).

What is claimed is:

1. A magnetic mechanism for holding and moving a Hollow sphere/ball on a surface, which comprises:
a hollow, generally spherical plastic object comprising of a shell and that it has a Ferromagnetic metal that either is attached to its shell, or, forms part of or the whole of, another object that would be contained within the hollow/cavity of the generally spherical plastic object;
a object or device that has, or is capable of generating a, magnetic field;
a board shaped object that the majority of which is made from a non-magnetic material, having the majority of its surface area made up from two of its sides running in parallel or close to parallel with each other giving it two main side surfaces;
whereby,
at least one of the said generally hollow spherical object, would be in contact with at least one main side of the said board shaped object and the other main side of the said board shaped object was facing at least one, or more, object/s or device/s that has or is capable of generating a magnetic field, so that the position of the said board shaped object was in-between the said generally hollow spherical object and at least one of the said object/s or device/s that has or is capable of generating a magnetic field, and that the position of at least one, or more, of the said object/s or device/s that has or is capable of generating a magnetic field/s, that could be either stationary or changing, would allow for its/their magnetic field/s to be attracted to any ferromagnetic metal, located inside or on, of the said generally spherical object that would be touching the said board shaped object, to the point where its/their combined strength of its/their magnetic field/s could hold the said generally spherical object with enough force to the surface of the said board shaped object that the said generally spherical object is in contact with, so that, its/their magnetic fields would support the entire weight, against gravity, of the said generally spherical object and any object/s contained within it.

2. The device of claim 1, whereby any movement of any of their object/s or device/s that has or is capable of generating a magnetic field/s, is achieved with, one or more of the methods of creating a force being, gravity, hand power, magnetic field/s, air pressure, suction, water pressure, being coupled to or linked to any type of actuator.

3. The device of claim 1, whereby a change in the distance or gap between the location of at least one, or more, statically positioned or moving, object/s or device/s that has or is capable of generating a magnetic field/s and any magnetically held generally spherical object/s they may be coupled too, would result in, any of the generally spherical object's becoming detached from the in-between's surface that any of the generally spherical object's are being held to.

4. The device of claim 1, whereby a change in the distance or gap between the location of at least one, or more, statically positioned or moving, object/s or device/s that has or is capable of generating a magnetic field/s and any magnetically held generally spherical object/s they may be coupled too, would result in, the magnetic hold strength coupling at least one, or more, of the said object/s or device/s that has or is capable of generating a magnetic field/s to the said generally spherical object/s to decrease or increase in strength.

5. The device of claim 2, whereby the said movement can follow a path, created by or linked to one, or more method/s of directed movement being, a chain drive, a belt drive, a linear drive, a type of channel, a pulley system, a directional support structure, a mechanism that is attached to or forms part of an actuator.
